(19) United States
(12) Patent Application Publication
(10) Pub. No.: US 2011/0093555 A1
(43) Pub. Date: Apr. 21, 2011

(54) Methods Circuits Devices Systems and Associated Code for Operating a Computing Platform

(76) Inventors: NIR DARY, Maaleh Adumim (IL); Benyamin HAYUMI, Jerusalem (IL); Eran KESSEL, Jerusalem (IL)

(21) Appl. No.: 12/906,889

(22) Filed: Oct. 18, 2010

Related U.S. Application Data
(60) Provisional application No. 61/252,690, filed on Oct. 18, 2009.

(51) Int. Cl. G06F 15/16

(52) U.S. Cl. 709/208

(57) ABSTRACT

Disclosed are methods, circuits, devices, systems and associated code for operating one or more computing platforms. According to embodiments, there is provided a device for operating one or more computing platforms. The device may include a first interface circuit, of a first interface circuit type, adapted to connect with a computing platform interface circuit, such that said first interface circuit is operative to transmit basic user input commands to the computing platform and to receive data derived from a display buffer and/or from an audio buffer of the computing platform. The device may include a second interface circuit, of a second interface circuit type, adapted to communicate with a networked control appliance (control appliance) through a network and further adapted to: (1) receive from the control appliance packetized basic user input commands for the computing platform, and (2) transmit to the control appliance packets with data derived from a display buffer and/or from an audio buffer of the computing platform. Processing circuitry of the device may be adapted to coordinate data flow between said first interface circuit and said second interface circuit.

### RELATED APPLICATIONS

The present application claims priority from U.S. Provisional Patent Application Ser. No. 61/252,690, which is hereby incorporated by reference in its entirety.

### FIELD OF THE INVENTION

The present invention relates generally to the field of Computing. More specifically, the present invention relates to Methods, Devices, Circuits, Systems and Associated Code for Operating a Computing Platform.

### BACKGROUND

A KVM switch (Keyboard, Video or Visual display unit, Mouse) is a hardware device that connects to the Keyboard, Video and Mice ports of multiple computers, and allows a user to control these multiple computers from a single keyboard, video monitor and mouse. Although multiple computers are connected to the KVM, typically a smaller number of computers can be controlled at any given time. Modern devices have also added the ability to share USB devices and speakers with multiple computers. Some KVM switches can also function in reverse—that is, a single PC can be connected to multiple monitors, keyboards, and mice. While not as common as the former, this configuration is useful when the operator wants to access a single computer from two or more (usually close) locations for example, a public kiosk machine that also has a staff-maintenance interface behind the counter, or a home office computer that doubles as a home theater PC.

Still remains a need for remote computer access/control solutions that have no, or less, dependency on the healthiness and/or condition of the accessed computer(s)' operating system and/or the condition of its hardware; possibly, without requiring a substantial hardware overhead.

### SUMMARY OF THE INVENTION

The present invention includes methods, devices, circuits, systems and associated code for operating a computing platform such a personal computer, computer server or any other computing platform, which computing platform(s) may include one or more processors and one or more data storage devices. According to some embodiments of the present invention, there may be provided a composite device which composite device may include: a first interface circuit of a first interface circuit type adapted to interface with a computing platform, a second interface circuit of a second interface circuit type adapted to interface with a data network appliance, a non-volatile memory adapted to store code suitable for operating at least a portion of the computing platform, and control logic (e.g. controller, processor or processing circuitry) adapted to coordinate signal/data flow between various portions of the composite device. According to further embodiments of the present invention, the control logic may also be adapted to facilitate and/or regulate data flow between a computing platform connected to the composite device through the first interface circuit and a data network appliance (e.g. server or client device/application) connected to the composite device through the second interface circuit. The data network appliance may be a networked control appliance, such a network computer running a control application adapted to communicate with the composite device.

According to some embodiments, the device for operating a computing platform may include a first interface circuit, of a first interface circuit type, adapted to connect with a computing platform interface circuit, such that said first interface circuit is operative to transmit basic user input commands to the computing platform and to receive data derived from a display buffer and/or from an audio buffer of the computing platform. The device may include a second interface circuit, of a second interface circuit type, adapted to communicate with a networked control appliance (control appliance) through a network and may be further adapted to: (1) receive from the control appliance packetized basic user input commands for the computing platform, and (2) transmit to the control appliance packets with data derived from a display buffer and/or from an audio buffer of the computing platform. Processing circuitry of the device may be adapted to coordinate data flow between said first interface circuit and said second interface circuit.

The first interface circuit type may be a type selected from the group consisting of Universal Serial Bus (USB), Firewire, Transferjet, and point-to-point interface circuits. The second interface circuit type may be of a type selected from the group consisting of Ethernet, Fiber Channel and networking interface circuits.

The device may include a non-volatile memory (NVM) functionally associated with the processing circuitry, and the processing circuitry may be adapted to provide the computing platform read access to executable code stored on said NVM. The processing circuitry may provide the control appliance write access to the NVM. The code stored on the NVM may be code of a type selected from the group of code types consisting of: (1) input device drivers, (2) output interface drivers, (3) basic input output (BIOS) patch, (4) boot managing code, (5) crash recovery applications, (6) data recovery applications, (6) operating systems segments, and (6) complete operating systems.

The code stored on the NVM may cause the computing platform to recognize the second interface circuit as a native network port.

The code stored on the NVM may cause the computing platform to recognize user input commands received through said first interface circuit as user commands originating at a local user input peripheral.

The code stored on the NVM may cause the computing platform to transmit data derived from a display and/or audio buffer of the computing platform to the control appliance via the first interface circuit.

The device may include additional interface circuits of the first interface circuit type, wherein each of the additional interface circuits may be adapted to connect with a separate computing platform.

According to embodiments, there may be provided a computing cluster including two or more computing platforms functionally associated with a composite device having two or more first type interface circuits of a first interface circuit type. Each of the first type interface circuits may be connected to a respective computing platform, and each first type interface circuit may be operative to transmit basic user input commands to its respective computing platform and to receive data derived from a display buffer and/or from an audio buffer of its computing platform.

The composite device may include at least one second type interface circuit of a second interface circuit type adapted to communicate with a networked control appliance (control appliance) through a network and may be further adapted to: (1) receive from the control appliance packetized basic user input commands for the computing platform, and (2) transmit to the control appliance packets with data derived from a display buffer and/or from an audio buffer of the computing platform.

The composite device may include processing circuitry adapted to coordinate data flow between one or more of the first type interface circuits and the second type interface circuit. According to further embodiments, the composite device may include two or more second interface type interface circuits and the processing circuitry may be adapted to regulate signal/data flow between any of the first type interfaces and any of the second type interfaces.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows an example of a prior art regular KVM;

FIG. 2 shows an example of a prior art remote KVM;

FIG. 3 shows an example of a prior art KVM controlled by a remote KVM application;

FIG. 4 is an exemplary schematic diagram showing elements of a composite device according to embodiments of the invention;

FIG. 5 is an exemplary topology of the system according to some embodiments of the present invention;

FIG. 6 is another exemplary topology of the system according to some embodiments of the present invention showing the composite device controlling multiple computing platforms;

FIG. 7 is another exemplary topology of the system according to some embodiments of the present invention showing two remote control applications controlling the computing platforms; and

FIG. 8 is another exemplary topology of the system according to some embodiments of the present invention showing redundant communication between the remote control application and the composite device.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

Furthermore, it should be understood that any topology, technology, protocol and/or standard for computer networking, known today or to be devised in the future, may be applicable to the present invention.

The present invention includes methods, devices, circuits, systems and associated code for operating a computing platform such a personal computer, computer server or any other computing platform, which computing platform(s) may include one or more processors and one or more data storage devices. According to some embodiments of the present invention, there may be provided a composite device which composite device may include: a first interface circuit of a first interface circuit type adapted to interface with a computing platform, a second interface circuit of a second interface circuit type adapted to interface with a data network appliance, a non-volatile memory adapted to store code suitable for operating at least a portion of the computing platform, and control logic (e.g. controller, processor or processing circuitry) adapted to coordinate signal/data flow between various portions of the composite device. According to further embodiments of the present invention, the control logic may also be adapted to facilitate and/or regulate data flow between a computing platform connected to the composite device through the first interface circuit and a data network appliance (e.g. server or client device/application) connected to the composite device through the second interface circuit. The data network appliance may be a networked control appliance, such a network computer running a control application adapted to communicate with the composite device.

According to some embodiments of the present invention, the NVM memory on the composite device may include code which the computing platform may boot from and/or otherwise execute. The code (bootable or not) may include part or all of an operating system suitable for the computing platform, drivers suitable for some or all of the hardware of the computing platform, and/or some or all of an Internet Protocol Stack for the computing Platform.

According to some embodiments, the first interface circuit, along with the control logic, may provide the computing platform access to the composite device's non-volatile memory and code stored thereon. The computing platform may boot from and/or execute code stored on the composite device's non-volatile memory. One or more drivers stored on the non-volatile memory and executed on the computing platform may cause the computing platform to: (1) recognize one or more of the second interface circuits on the composite device as a (native) Ethernet circuit/port, (2) send data from the computing platform's video display buffer to the composite device through the first interface circuit, (3) send data from the computing platform's audio output circuits/buffers to the composite device through the first interface circuit, and/or (4) receive keyboard and/or mouse commands through the first interface circuit and to execute the received commands as if though they originated from a keyboard or mouse connected to the computing platform.

According to further embodiments, the control logic (e.g. controller and/or other circuitry functionally associated therewith) may packetize video/audio data received from the computing platform and forward the video/audio data bearing packets to a control device/computer/appliance over an IP network. According to further embodiments, there may be provided a control device/computer executing code (e.g. application) adapted to display and/or play video/audio data received from the composite device. The code running on the control device/computer may be adapted to send packetized keyboard/mouse commands to the computing platform from which the video/audio originated through the composite device. The composite device (e.g. the control logic or associated circuit) may be adapted to translate the packetized keyboard/mouse commands into signaling suitable for transmission, through the first interface, to a driver running on the computing platform.

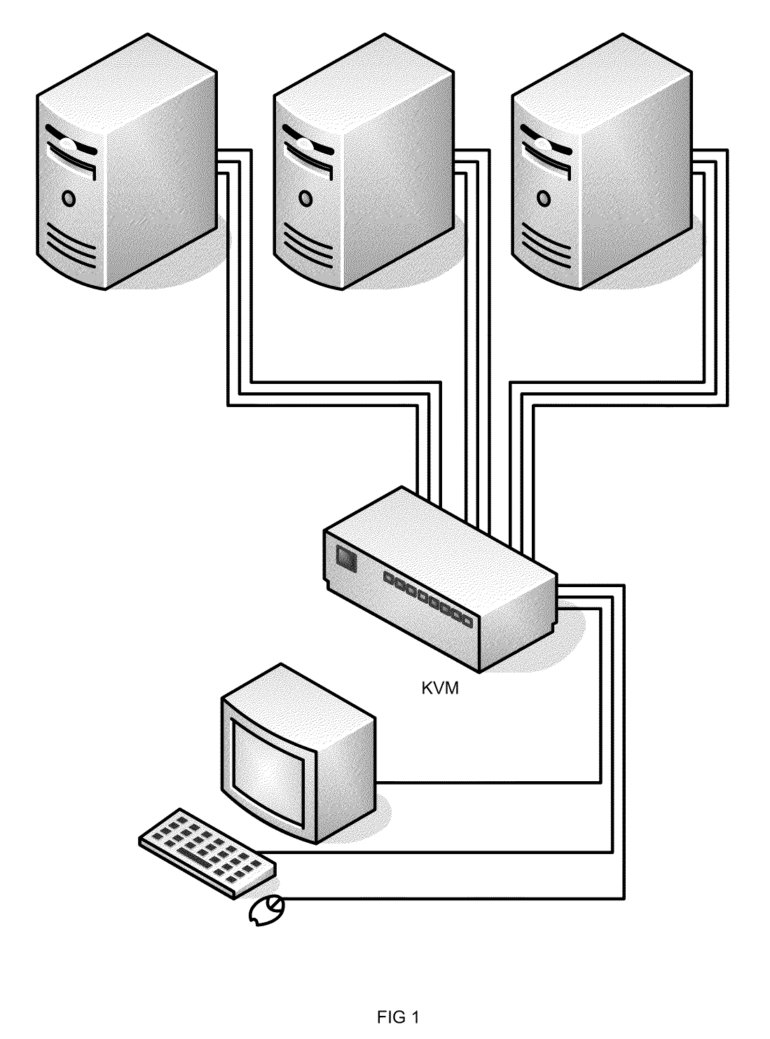

FIG. 1 is an exemplary schematic description of a prior art KVM (Keyboard, Video, Mouse) device. In this example 3 servers are connected to the KVM device with 3 cords each, the first cord connecting the screen video output from the server to the KVM, the second cord connects the mouse output of the server to the KVM, and the third cord connects the server's keyboard output to the KVM. The KVM has a screen, a keyboard and a mouse connected to it, which can be switched by the KVM and connected to one of each of the three servers.

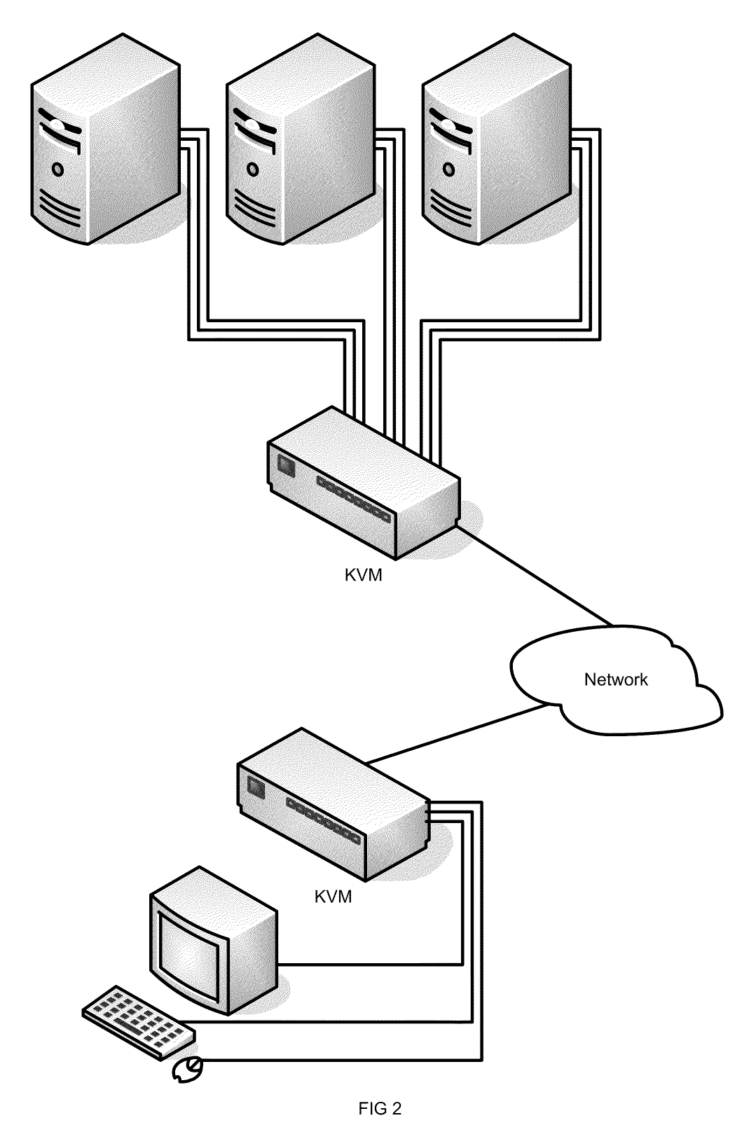

FIG. 2 is an exemplary schematic description of a prior art remote KVM device. In this example 3 servers are connected to a first KVM device as in the example of FIG. 1. A keyboard, screen and mouse are connected to a second KVM device at a remote location. The first and second KVM devices communicate between them over a network and can transfer mouse and keyboard commands to any of the selected servers and display the video from any of the selected servers on the remote screen.

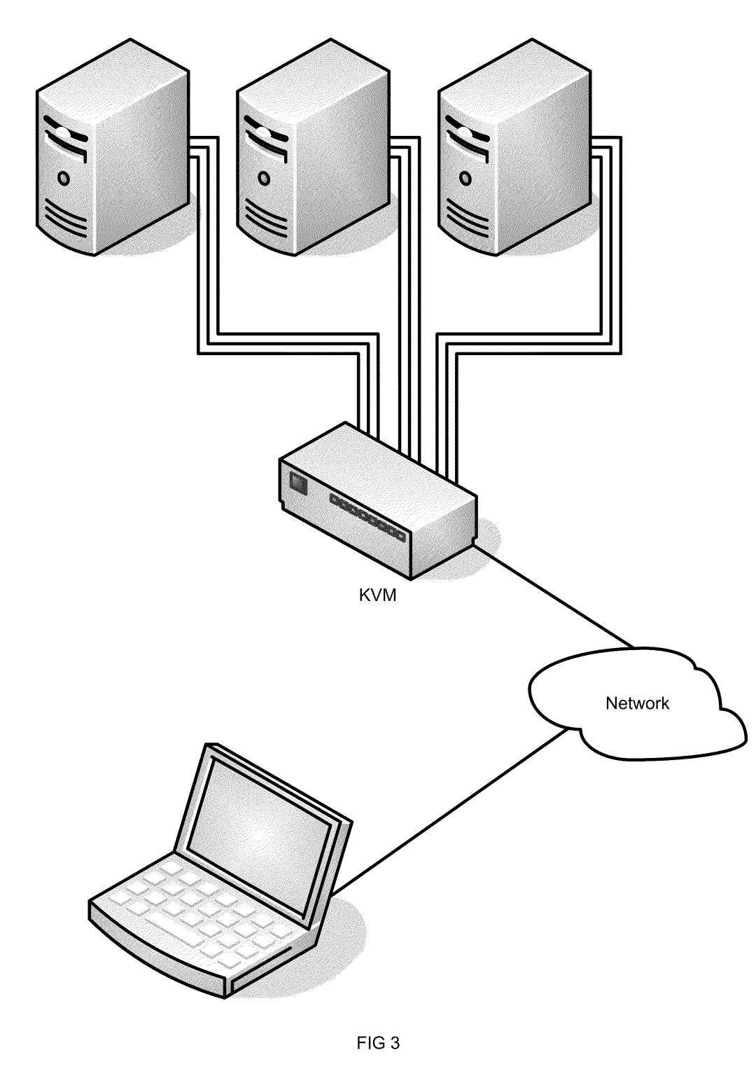

FIG. 3 is an exemplary schematic description of a prior art remote KVM device. In this example 3 servers are connected to the KVM device as in the example of FIG. 1. A remote desktop or personal computer communicates with the KVM over the network. The remote computer displays the video of any of the selected servers and sends keyboard and mouse command to any of the selected servers over the network.

According to some embodiments of the present invention, there may be provided a composite device including: a first interface circuit adapted to interface with a computing platform, a second interface circuit adapted to interface with a data network appliance, a non-volatile memory adapted to store code suitable for operating at least a portion of the computing platform, and control logic adapted to coordinate signal flow between various portions of the composite device. According to further embodiments of the present invention, the control logic may also be adapted to facilitate and/or regulate data flow between a computing platform connected to the composite device through the first interface circuit and a data network appliance connected to the composite device through the second interface circuit. It should be understood that any combination of two or more of the aforementioned circuits may be part of a single circuit, for example an integrated circuit fabricated on a semiconductor die. Conversely, each of the aforementioned circuits may be composed of two or more functionally associated circuits working in concert.

According to some embodiments of the present invention, the first interface circuit may be functionally associated with a physical interface port, socket or plug—for example such as a Universal Serial Bus (“USB”) port, socket or plug.

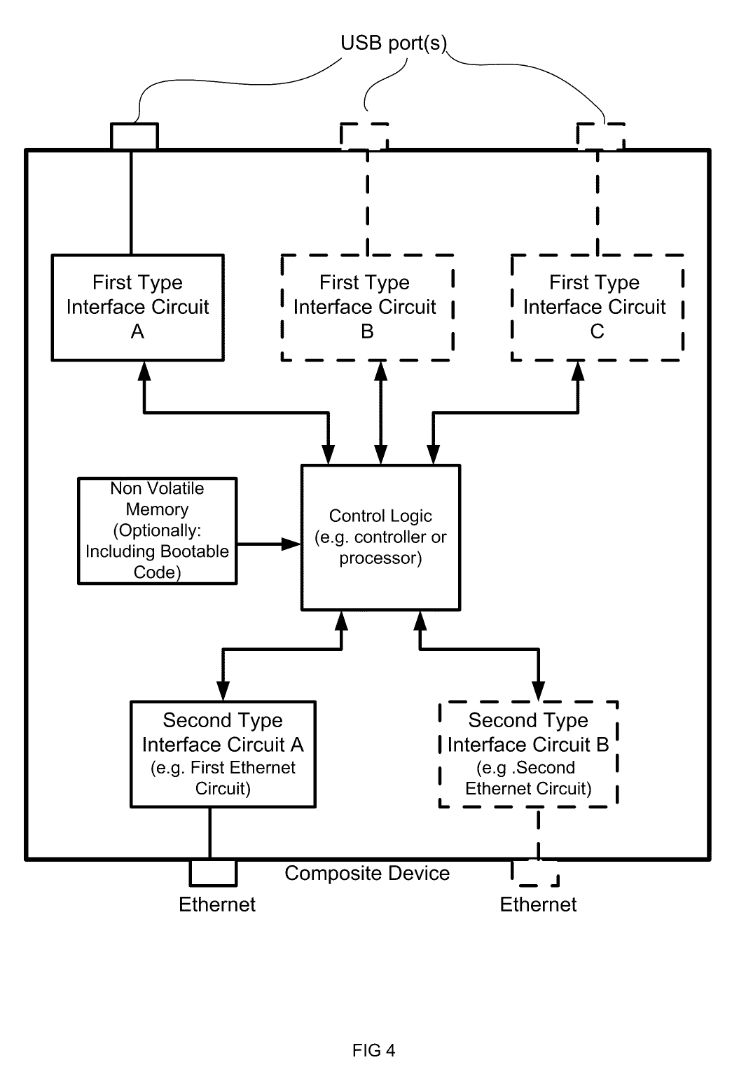

FIG. 4 shows a schematic example of the composite device. The composite device may have at least one port (in this example, a USB port), which may connect to at least one computing platform (in this example, to the USB port of the computing platform). The USB port(s) may be attached to at least one first interface circuit(s) which may handle the communication with the computing platform(s) through the USB port(s). The composite device may also have at least one network port (in this example, an Ethernet port), which may connect to at least one network device. The network port(s) may be attached to at least one second interface circuit(s) which may handle the communication with the network device. The composite device according to this example may also include a Non Volatile Memory (NVM) such as Flash memory for storing any or all of: 1) code run by the composite device's controller; 2) USB removable data storage device emulation code; 3) boot code to be run by the computing platform; 3) an Operating System (OS) to be loaded and run by the computing platform; 4) an Internet Protocol (IP) Stack to be loaded and run by the computing platform; 5) drivers to be loaded and run by the computing platform for operation of the second interface circuit(s) on the composite device; 6) remote access application to be loaded and run by the computing platform for providing external control over a computing platform; 7) an Internet Protocol (IP) Stack to be run by the composite device; 8) a reload application to be run by the composite device for downloading new code through the second interface circuit and updating the NVM code and the control logic circuits, In the example of FIG. 4, the composite device may also include a controller (control logic) for controlling signal flow within the composite device and data flow to and from the first and second interface circuits and the Non Volatile Memory (NVM).

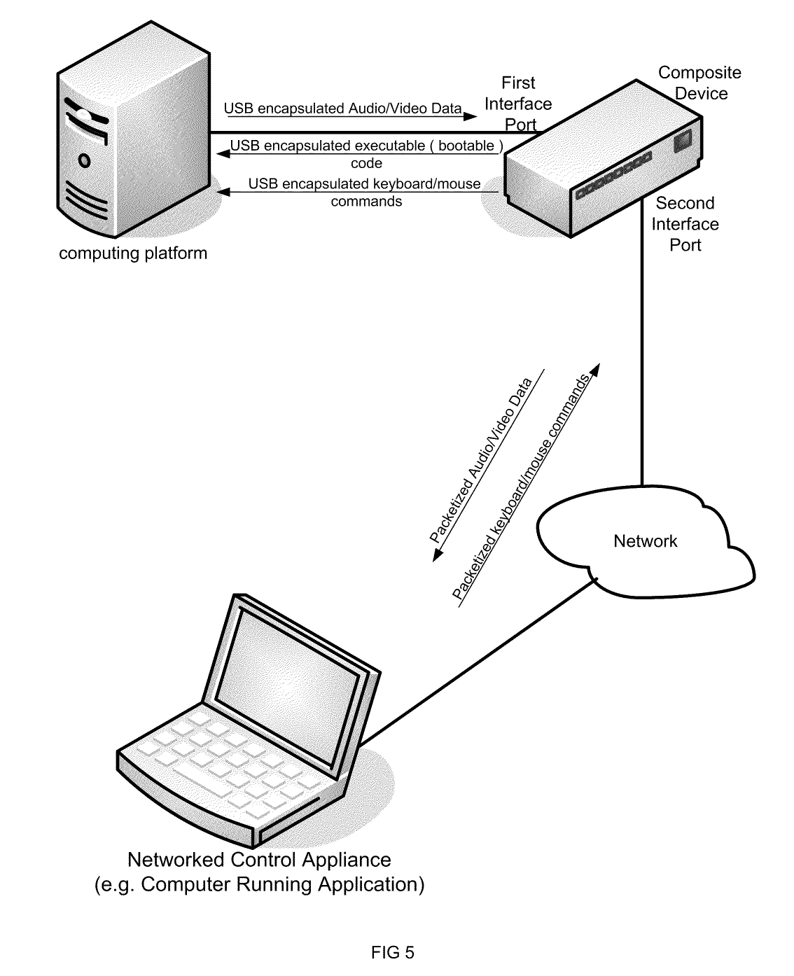

FIG. 5 shows an example of the composite device connected to a computing platform through the first interface port, and connected to the network through the second interface port. According to the example, a control application running on a remote computer, communicates with the composite device over the network and controls the computing platform, or communicates with the computing platform directly over the network using the composite device as the computing platform's network interface.

According to further embodiments of the present invention, the controller operating in concert with the first interface circuit and with the non-volatile memory may emulate a removable data storage device, and a computing platform interfaced to the composite device through the first interface circuit may read data from the non-volatile memory. According to further embodiments of the present invention, the non-volatile memory may include a sector of data (e.g. a boot-sector) usable by a computing platform for loading and/or instancing an operating system, which operating system code may also be stored on the non-volatile memory.

According to further embodiments of the present invention, the second interface circuit may be a data networking interface, for example an Internet Protocol (“IP”) interface. According to some embodiments of the present invention, each composite device may have a unique data network address or indicator associated with its second interface circuit. Accordingly, each composite device may be selectively communicated with by an external application. According to some other embodiments of the present invention, each composite device may have a unique data network address or indicator associated with each of its first interface circuits. Accordingly, each first interface circuit of each composite device may be selectively communicated with by an external application. According to some embodiments of the present invention, a first interface circuit may be assigned the network address of the computing platform connected to it.

According to further embodiments of the present invention, the operating system code stored on the non-volatile memory may include at least a portion of an Internet Protocol Stack and one or more drivers for operation of the second interface circuit on the composite device. The control logic functioning in conjunction with one or more drivers loaded from the NVM by a computing platform may facilitate the use of the second interface circuit as a (e.g. native) network interface by a computing platform connected to the composite device through the first interface circuit. The operating system code stored in the device may include a remote access application providing external control over a computing platform executing the code.

According to further embodiments of the present invention, the composite device may provide to an external application or a user using an external application, such as a KVM application, control over a computing platform connected to the composite device through the first interface circuit. The external application or a user using the external application may establish an Internet Protocol communication session with the composite device through its second interface circuit, and the control logic may convert commands received from the external application over the IP session into commands recognized by the computing platform's bios. Conversely, output signals received from the computing platform through the first interface circuit may be converted by the control logic into IP signals/packets indicative of the output, which signals/packets may be relayed to the external application through the second interface circuit.

According to further embodiments of the present invention, either the control logic and/or the code stored on the NVM may be altered remotely by an external application running on a computer connected to the composite device through the second interface circuit—for example by IP piping into the composite device.

The control logic (e.g. controller) may facilitate each of the above mentioned stated functions.

A composite device according to some embodiments may include multiple interface circuits having substantially the same structure and function as the above stated first interface circuit. Accordingly, one composite device may be interfaced with multiple computing platforms. Likewise, a composite device according to some embodiments may include multiple interface circuits having substantially the same structure and function as the above second interface circuit, thereby providing redundant communication paths to the composite device.

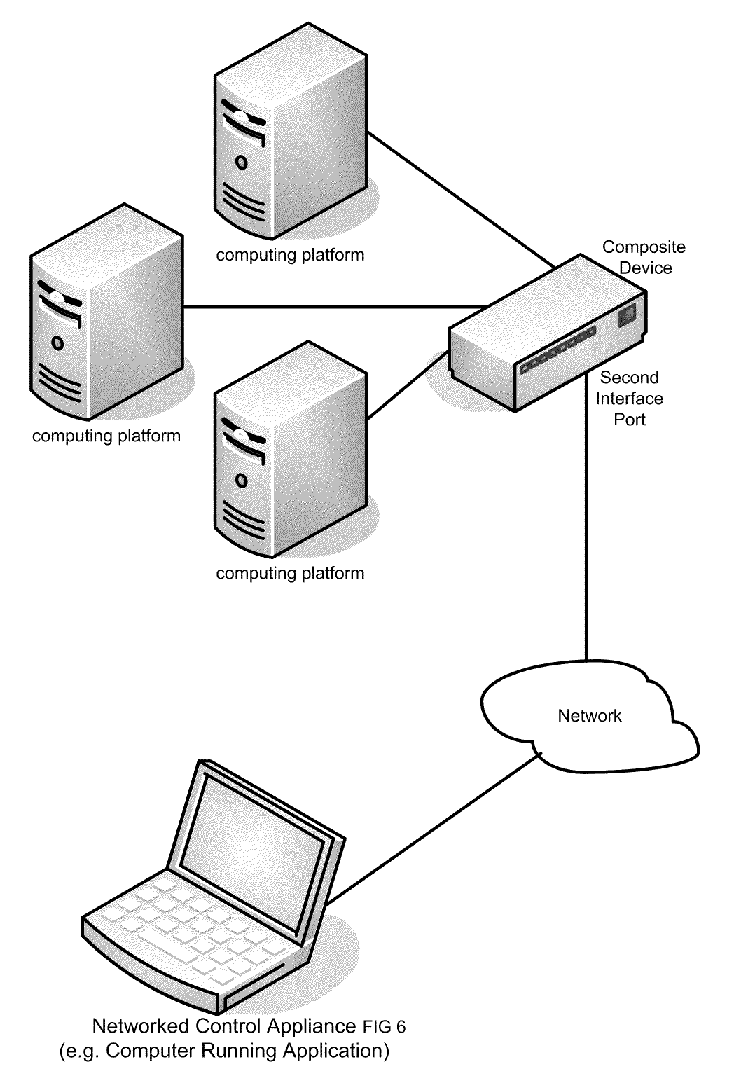

FIG. 6 is an example similar to FIG. 5 but with multiple interface circuits having substantially the same structure and function as the first interface circuit. The multiple interface circuits are connected to multiple computing platforms. The remote control application can selectively control each computing platform by communicating with the composite device according to its designated address (such as IP address) and selecting the controlled computing platform from a list associated with the computing platforms connected to the composite device. Alternatively, the remote control application can selectively control each computing platform by communicating with the computing platform according to the designated address (such as IP address) of the first interface the controlled computing platform is connected to.

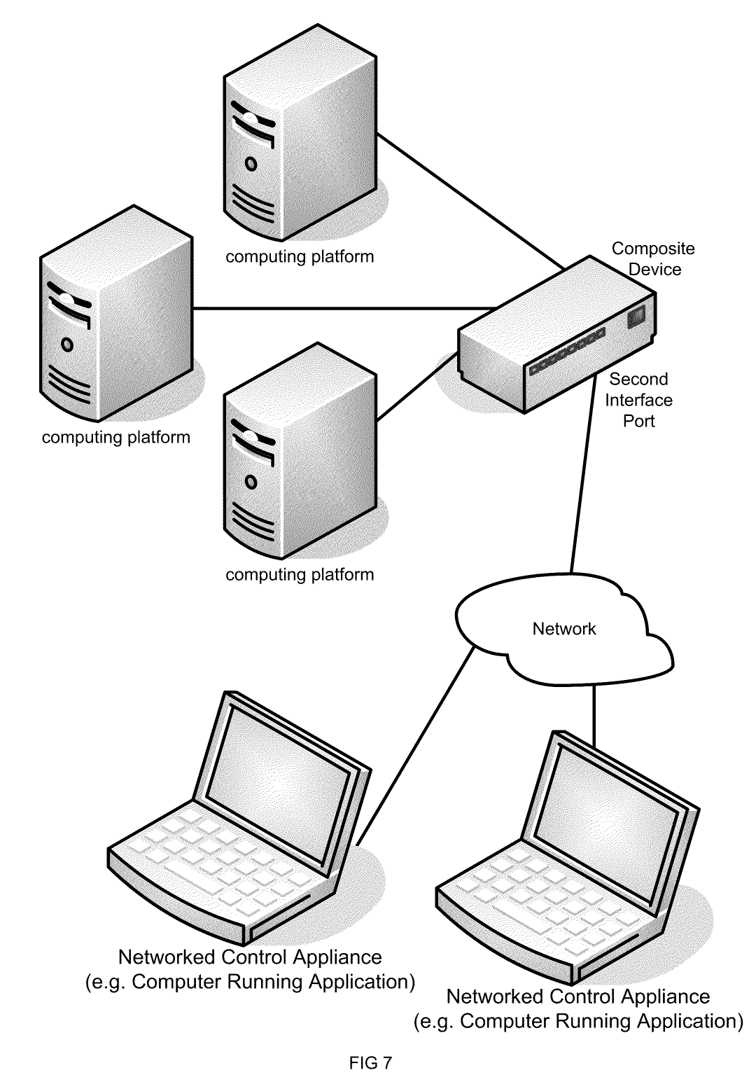

FIG. 7 is an example similar to the example shown in FIG. 6 but having two remote control applications, each of them able to control the computing platform separately.

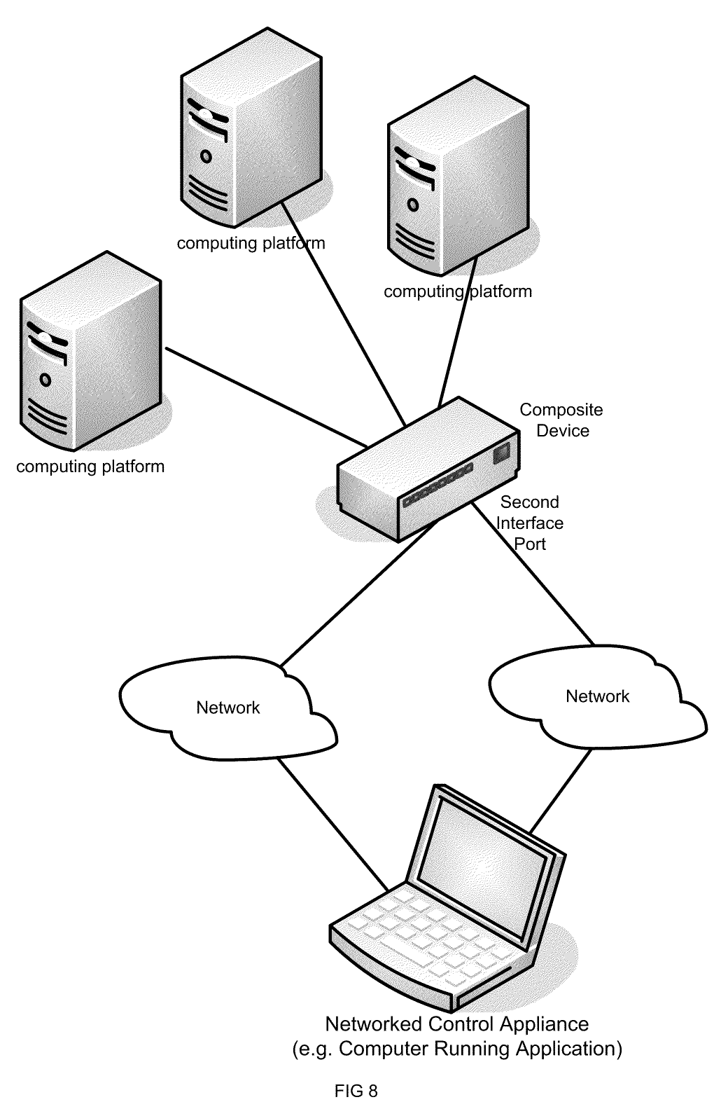

FIG. 8 is another example similar to the one shown in FIG. 6. In this example a remote control application may communicate with the composite device through two separate networks The configuration shown in this example provides redundancy so that in the case that one network fails, the computing platform may still be controlled using the redundant network.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A device for operating a computing platform, said device comprising:
a first interface circuit, of a first interface circuit type, adapted to connect with a computing platform interface circuit, such that said first interface circuit is operative to transmit basic user input commands to the computing platform and to receive data derived from a display buffer and/or from an audio buffer of the computing platform;
a second interface circuit, of a second interface circuit type, adapted to communicate with a networked control appliance (control appliance) through a network and further adapted to: (1) receive from the control appliance packetized basic user input commands for the computing platform, and (2) transmit to the control appliance packets with data derived from a display buffer and/or from an audio buffer of the computing platform; and
processing circuitry adapted to coordinate data flow between said first interface circuit and said second interface circuit.

2. The device according to claim 1, wherein said first interface circuit type is of a type selected from the group consisting of Universal Serial Bus (USB), Firewire, Transferjet, and point-to-point interface circuits.

3. The device according to claim 1, wherein said second interface circuit type is of a type selected from the group consisting of Ethernet, Fiber Channel and networking interface circuits.

4. The device according to claim 1, further comprising a non-volatile memory (NVM) functionally associated with said processing circuitry, wherein said processing circuitry is further adapted to provide the computing platform read access to executable code stored on said NVM.

5. The device according to claim 4, wherein said processing circuitry is further adapted to provide the control appliance write access to said NVM.

6. The device according to claim 4, wherein the code stored on said NVM is code of a type selected from the group of code types consisting of: (1) input device drivers, (2) output interface drivers, (3) basic input output (BIOS) patch, (4) boot managing code, (5) crash recovery applications, (6) data recovery applications, (6) operating systems segments, and (6) complete operating systems.

7. The device according to claim 6, wherein code stored on said NVM is adapted to cause the computing platform to recognize said second interface circuit as a native network port.

8. The device according to claim 6, wherein code stored on said NVM is adapted to cause the computing platform to recognize user input commands received through said first interface circuit as user commands originating at a local user input peripheral.

9. The device according to claim 6, wherein code stored on said NVM is adapted to cause the computing platform to transmit data derived from a display and/or audio buffer of the computing platform to said control appliance via said first interface circuit.

10. The device according to claim 1 further comprising additional interface circuits of said first interface circuit type, wherein each of said additional interface circuits is adapted to connect with a separate computing platform.

11. A computing cluster comprising:
two or more computing platforms functionally associated with a composite device comprising:
(a) two or more first type interface circuits of a first interface circuit type, wherein each of said first type interface circuits are connected to a respective computing platform, and each first type interface circuit is operative to transmit basic user input commands to its respective computing platform and to receive data derived from a display buffer and/or from an audio buffer of its computing platform;
(b) at least one second type interface circuit of a second interface circuit type adapted to communicate with a networked control appliance (control appliance) through a network and further adapted to: (1) receive from the control appliance packetized basic user input commands for the computing platform, and (2) transmit to the control appliance packets with data derived from a display buffer and/or from an audio buffer of the computing platform; and
(c) processing circuitry adapted to coordinate data flow between one or more of said first type interface circuits and said second type interface circuit.

12. The cluster according to claim 11, wherein said first interface circuit type is of a type selected from the group consisting of Universal Serial Bus (USB), Firewire, Transferjet, and point-to-point interface circuits.

13. The cluster according to claim 11, wherein said second interface circuit type is of a type selected from the group consisting of Ethernet, Fiber Channel and networking interface circuits.

14. The cluster according to claim 11, further comprising a non-volatile memory (NVM) functionally associated with said processing circuitry, wherein said processing circuitry is further adapted to provide one or more of the computing platforms read access to executable code stored on said NVM.

15. The cluster according to claim 14, wherein said processing circuitry is further adapted to provide the control appliance write access to said NVM.

16. The cluster according to claim 14, wherein the code stored on said NVM is code of a type selected from the group of code types consisting of: (1) input device drivers, (2) output interface drivers, (3) basic input output (BIOS) patch, (4) boot managing code, (5) crash recovery applications, (6) data recovery applications, (6) operating systems segments, and (6) complete operating systems.

17. The cluster according to claim 16, wherein code stored on said NVM is adapted to cause one or more of the computing platforms to recognize said second interface circuit as a native network port.

18. The cluster according to claim 16, wherein code stored on said NVM is adapted to cause one or more of the computing platforms to recognize user input commands received through said first interface circuit as user commands originating at a local user input peripheral.

19. The cluster according to claim 16, wherein code stored on said NVM is adapted to cause one or more of the computing platforms to transmit data derived from a display and/or audio buffer of the computing platform to said control appliance via said first interface circuit.

20. The cluster according to claim 11 further comprising additional first type interface circuits of said first interface circuit type, wherein each of said additional interface circuits is connected with a separate computing platform.
